(19) United States
(12) Patent Application Publication
(10) Pub. No.: US 2026/0236005 A1
(43) Pub. Date: Aug. 13, 2026

(54) CABLE PROCESSING MACHINE AND METHOD OF OPERATING A CABLE PROCESSING MACHINE

(71) Applicant: Schleuniger AG, Thun (CH)

(72) Inventors: Thomas NYFFENEGGER, Steffisburg (CH); Burim SELIMI, Faulensee (CH)

(73) Assignee: Schleuniger AG, Thun (CH)

(21) Appl. No.: 19/152,542

(22) PCT Filed: Feb. 1, 2023
(86) PCT No.: PCT/IB2023/050879

§ 371 Date: Jul. 31, 2025

(51) Int. Cl. G05B 19/409; H02G 1/12

(52) U.S. Cl. CPC G05B 19/409; H02G 1/1248; G05B 2219/23129; G05B 2219/23171; G05B 2219/23174

(57) ABSTRACT

The invention provides a cable processing machine (100) for the processing of a blank-cable (1) into a tooled-cable (2). The cable processing machine comprises an operating tool (110, 120, 130), a sensor (111, 121, 131), a display (200), and a control system (300). The control system (300) is arranged to set a target configuration of the operating tool (110, 120, 130) based on a cable-type (3) of the blank-cable (1) to be processed. The sensor (111, 121, 131) provides a sensor signal (112, 122, 132) indicative of the actual configuration of the operating tool (110, 120, 130). The control system (300) is further arranged to provide display data (310, 320, 330) on the basis of the sensor signal (112, 122, 132) and the cable-type (3), which display data are displayable on the display (200). Individual items of the display data (310, 320, 330) are displayable in an animatable representation (5) of the tooled-cable (2) on the display (200) in which possible failure modes for individual components of the tooled-cable (2) are distinguishable from each other.

This invention relates to a cable processing machine according to the preamble of claim 1. The invention furthermore relates to a method of operating a cable processing machine according to the preamble of claim 9, and to a computer program product relating to such a method.

Cable processing machines are often designed and programmed to mass-produce processed cables, such as electrical or optical cables, in accordance with pre-defined specifications. As an example, the cable processing machine is programmed to produce an (electrical or optical) cable piece of a specified piece-length with the cable insulation stripped at one, or both, end(s) over a specified strip-length. Possibly and as an example of special operation on such a cable processing machine, the insulation stripped should not be removed completely, but only partly pulled-off for holding and protecting the bare core-wires of the electrical cable. In this latter case, the cable processing machine is programmed to shift the stripped insulation part (having a strip-length) over a specified pulled-off-length for leaving a gap between the unstripped insulation of central cable part and the partly pulled-off stripped insulation part. This is often called partial strip.

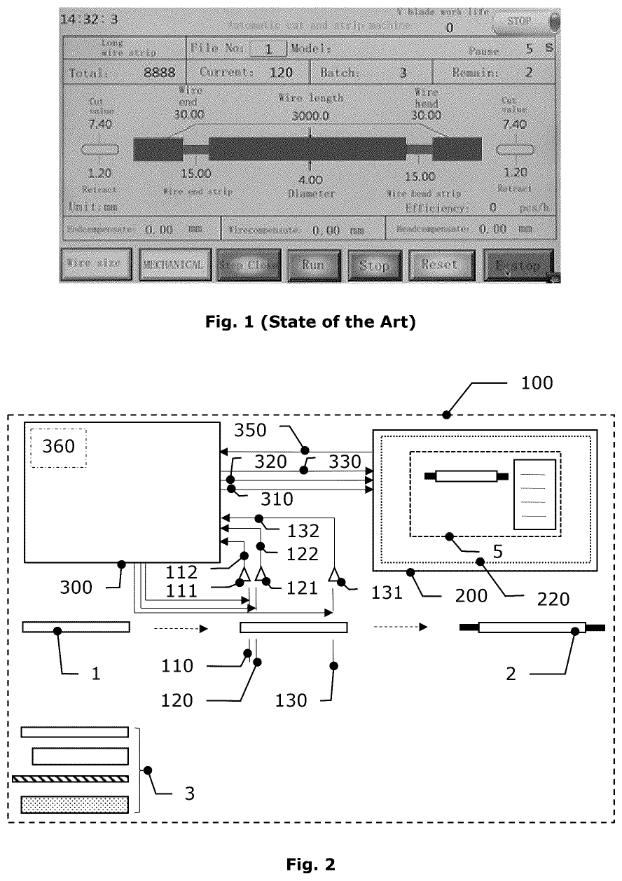

It is common practice, see FIG. 1, that on a (graphical) user interface of the cable processing machine, the specification (i.e. target physical dimensions) of the cable piece to be produced is displayed. Moreover, it is common practise that prior to starting a mass-production run on the cable processing machine, an operator calibrates or tunes the cable processing machine for the cable piece to be produced. To this end, the operator runs the cable processing machine in order to produce a sample piece and compares the (dimensions of the) sample piece produced with the desired dimensions of that cable piece. Based on the identified difference between the sample piece produced and the target to be achieved, the operator has to decide which cable processing machine settings need to be corrected or adjusted in order to minimize or eliminate the differences observed. Such corrections (for instance the relative starting distance of the stripping blades, or the pre-programmed cutting depth) can be entered through the user interface. This process of correcting or tuning, i.e. adjusting appropriate parameters, requires certain skills and knowledge of the operator. Subsequently, a new sample piece is produced for checking if the (dimensions of the) sample piece is within an acceptable production margin. These tuning and sample piece production steps are repeated until finally the cable processing machine is properly adjusted for starting a mass-production run. Especially inexperienced operators may select and adjust potentially irrelevant setting parameters, leading to an unnecessary lengthy calibration/tuning time and hence a reduced production efficiency. Such erroneous setting adjustments do not only produce waste but eventually may even harm the machine and/or its tools. This could be called a time consuming and dangerous multiple try and error process.

Thus, there is a need for a cable processing machine and a method for operating such a machine which enhances production efficiency by reducing, respectively minimising the (production) time lost in calibrating the machine. This is the objective of the invention.

The objective of the invention is solved by the features of the independent claims. Advantageous further developments are shown in the figures and in the dependent claims.

According to an aspect, the invention provides a cable processing machine for the processing/transforming of a blank-cable (i.e. an unprocessed cable including insulation) into a tooled-cable (i.e. a processed cable), the cable processing machine comprising an operating tool, a sensor, a display, and a control system; wherein the control system is arranged to set a target configuration of the operating tool based on a cable-type of the blank-cable to be processed and based on the desired target specification of the tooled-cable; wherein the sensor provides a sensor signal to the control system indicative of the actual configuration of the operating tool; wherein the control system is further arranged to provide display data on the basis of the sensor signal and the cable-type, which display data are displayable on the display; wherein individual items of the display data are displayable in an animatable representation of the tooled-cable on the display, in which animatable representation possible failure modes for individual components of the tooled-cable are distinguishable from each other. Advantageously, the invention provides an operator a continued and/or guided human-machine interaction process to assist in adjusting the setting of the cable processing machine during a tuning or calibration phase prior to starting mass fabrication of tooled-cables in a production phase. As a further advantage of the invention, the dependency of the display data on the sensor signal(s) allows to filter the most relevant failure modes out of a library of potential failure modes. Thereby, the tuning phase in which the cable processing machine is properly adjusted for mass production can be minimized. To this end, the cable processing machine may comprise a memory or storage device connected to the control system for storing the library of cable failure modes.

Advantageously, the animatable representation of a tooled-cable on the display in which possible failure modes for individual components of a tooled-cable are distinguishable from each other credibly assists the operator in performing his technical task of calibrating the cable processing machine by means of a continued and/or guided human-machine interaction process. For the assistance to the operator in performing his technical task provided by the invention is objectively, reliably and causally linked with the animatable representation of the tooled-cable on the display.

The control system and display according to the invention are not only adapted to show the operator how the desired target tooled-cable should look like (a pictorial representation including values of dimensions like diameters, lengths etc.) They may, in addition, be adapted to show the operator in an animatable fashion how typical deviating product parts look like. Showing deviating products (or product parts) supports and guides the operator in identifying the relevant setting parameters to be adjusted. By selecting an appropriate deviating product displayed, the control system and display may subsequently indicate to the operator which machine settings may be changed and how they may be changed in order to eliminate the difference between the tooled test-piece (or sample) and the target tooled-cable.

In an embodiment, the display comprises for that purpose a touch-screen arranged to generate a failure-mode control signal indicative of a failure-mode of the tooled-cable, and the control system is arranged to adjust the configuration of the operating tools based on the failure-mode control signal following the respective input of the operator through the touch-screen. Advantageously, the animatable representation comprises different displayable options, guiding and supporting the operator for indicating through the touch-screen which of those matches best with the detected failure.

In an embodiment, the animatable representation comprises for the above purpose a section-wise representation of the tooled-cable. This allows displaying possible failure modes of (sections of) the tooled-cable. Advantageously, this allows an operator to be guided through comparing a status of a tooled-cable test-piece with a predefined target status to misalignments in the configuration of the operating tools set in the cable processing machine. More advantageously, by providing a section-by-section representation of the cable the invention assists the operator in a systematic manner in the adjustment of the cable processing machine during the tuning phase.

In another embodiment, the individual items of the display data comprise configuration parameters of the operating tools associated with the failure mode displayed. Advantageously, individual items of the display data may be pictorial representations of specific parts of a tooled-cable showing possible failure modes of non-quality compliant tooled-cables. Examples of failure modes are: scratches on outer or inner insulation, non-removed parts of insolation, non-properly bent shielding braids, scratched or cut inner-core conductors, length differences relative to target values, etc. The pictorial representations guide and support the operator in identifying, from a comparison of the test-piece produced with the pictorial representations, the configuration parameter associated with the failure mode.

In yet another embodiment, the configuration parameters are displayed in order of relevance for correcting the failure mode. Advantageously, the displayed order of relevance guides and supports an operator in selecting and adjusting the configuration parameter most relevant for eliminating any deviation between the test-piece and the target tooled-cable.

In a further embodiment, as suggested above, the configuration parameters are changeable by an operator, preferably through the touch-screen, and the failure-mode control signal may comprise information relating to the to-be-changed configuration parameter. Advantageously, the animatable representation guides and supports the operator in an intuitive fashion to provide input for adjusting a parameter setting. Moreover, the input provided allows the control system to readjust the cable processing machine's settings for producing a tooled-cable within acceptable quality margins.

In another embodiment, the individual items of the display data comprise explanatory advice on the relationship between the occurrence of a failure mode and a setting of the configuration parameters of the operating tools associated with that failure mode. Advantageously, the explanatory advice in the animatable representation guides and supports the operator, as well as increases the operator's understanding of the cable processing machine and the influence of its parameter settings on the final product produced.

In another embodiment, the control system comprises an artificial intelligence unit for determining the adjustment of the configuration of the operating tools based on the failure-mode control signal. Preferably, the cable processing machine comprises to this end a detector, such as a camera, for inspecting a tooled-cable. A detector signal, representative of the inspected tooled-cable, such as a photo, may be fed as input to the artificial intelligence unit in combination with a sensor signal indicative of the actual configuration of the operating tool(s). The detector signal and associated sensor signal may also be stored in an appropriate database assessable to the artificial intelligence unit. Advantageously, the artificial intelligence unit, which may comprise intelligent algorithms—a category including heuristic methods, artificial neural networks and evolutionary (genetic) algorithms, provides as output a failure-mode control signal indicative of a failure-mode of the tooled-cable to the control system. The latter may be arranged to adjust the configuration of the operating tools based on the failure-mode control signal. With the adjusted configuration a new test-piece may be produced and inspected, enabling the artificial intelligence unit to learn associating specific failure modes with appropriate configuration settings. Moreover, the artificial intelligence unit may learn to prioritise which configuration settings of the cable processing machine are preferably adjusted to alleviate the failure mode. Furthermore, beside an order of priority of the different configuration settings, the artificial intelligence unit may provide preferred values or value ranges for the different configuration settings to alleviate the failure mode.

According to a second aspect, the invention provides a method of operating a cable processing machine for the processing of a blank-cable into a tooled-cable using an operating tool, the method comprising (i) setting a target configuration of the operating tool based on a cable-type of the blank-cable to be processed and based on the desired target shape of the tooled cable; (ii) providing a sensor signal indicative of the actual configuration of the operating tool; (iii) providing display data on the basis of the sensor signal and the cable-type; and (iv) displaying individual items of the display data in an animatable representation of the tooled-cable in which possible failure modes of individual components of the tooled-cable are distinguishable from each other.

According to a third aspect the invention provides a computer program product comprising instructions which, when the program is executed by a computer, cause the computer to carry out the method according to the second aspect of the invention.

Further advantages, features and details of the invention will be apparent from the following description, in which embodiments of the invention are described with reference to the drawings.

The list of reference signs as well as the technical content of the patent claims and figures are part of the disclosure. The figures are described coherently and comprehensively. Identical reference signs indicate identical components, reference signs with different indices indicate functionally identical or similar components.

The figures show:

FIG. 1 schematically shows a graphical user interphase of a cable processing machine according to the state of the art;

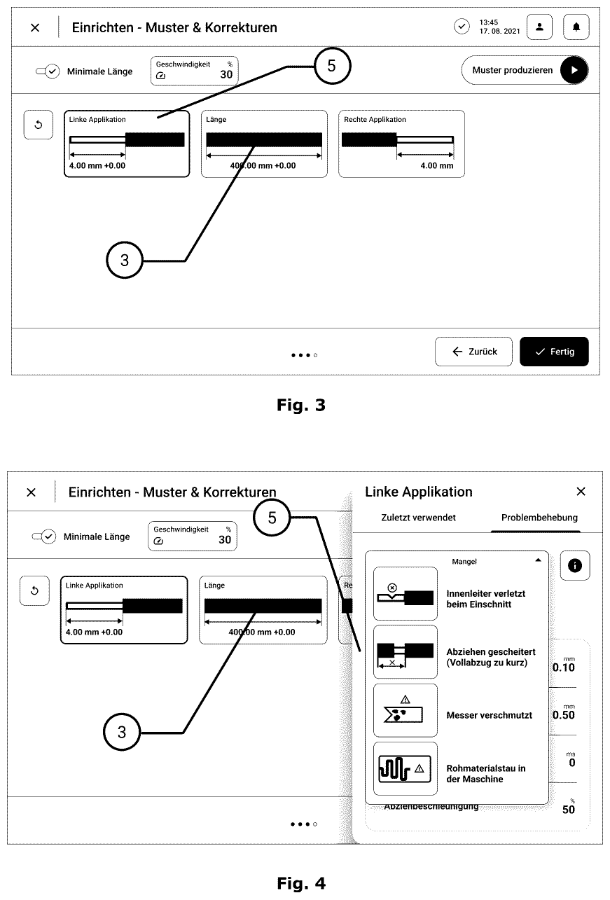

FIG. 2 a first embodiment of the cable processing machine according to the invention;

FIG. 3 shows a first embodiment of the animatable representation on the display according to the invention;

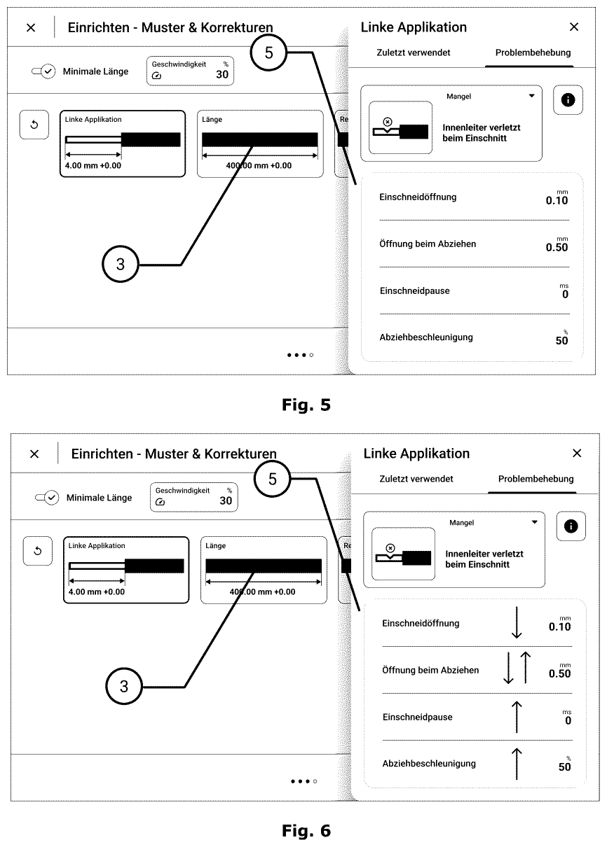

FIG. 4 shows a second embodiment of the animatable representation on the display according to the invention;

FIG. 5 shows a third embodiment of the animatable representation on the display according to the invention;

FIG. 6 shows a fourth embodiment of the animatable representation on the display according to the invention;

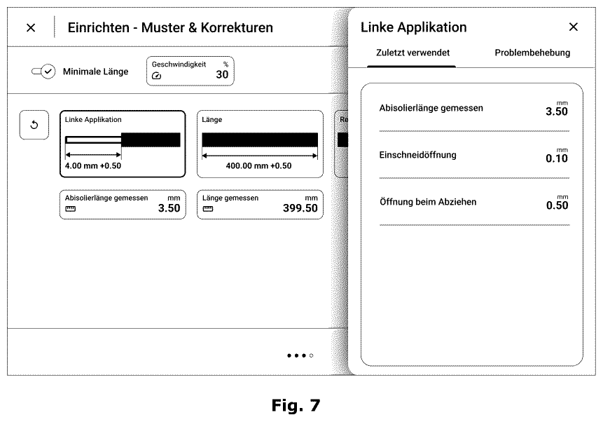

FIG. 7 shows a fifth embodiment of the animatable representation on the display according to the invention.

FIG. 2 schematically shows an example of a cable processing machine 100 according to the invention. Cable processing machine 100 is arranged to process a blank-cable 1 into a tooled-cable 2. The blank-cable (or raw-cable) 1 may be an electrical or optical cable which is in an unprocessed state. The blank-cable may be fed to the cable processing machine 100 from a wheel or a bobbin, or may be provided as a cable piece of predetermined length, for example introduced by a transfer mechanism. By using operating tools 110,120,130 on the cable processing machine 100, the blank-cable 1 is transformed into a tooled-cable (or processed-cable) 2. A blank-cable may be of a specific cable type 3, where the cable type is representative of physical characteristics of the blank-cable 1, such as overall diameter of the cable, thickness of the outer isolation, diameter of the inner conductor, single core/multiple cores, co-axial core, braided cable, flexibility of the cable, material characteristics of the isolation material (modulus elasticity, hardness, tensile strength, flexural strength, tensile elongation, . . . ) , etc.

The cable processing machine 100 comprises (at least one) an operating tool 110,120,130, a sensor 111,121,131, a display 200, and a control system 300. Operating tools 110,120,130 of the cable processing machine 100 are for instance cutting blades, stripping blades, alignment grippers, clamping tools, rollers, etc. The control system 300 is arranged to set a target configuration of the operating tool(s) 110,120,130 based on the cable-type 3 of the blank-cable 1 to be processed. Such a target configuration not only comprises the (predefined) physical starting position of the tools relative to each other, but also their (pre-programmed) operation mode for tooling or processing the blank-cable 1. Examples of such operating modes are the speed with which blades approach the cable, and the cutting-depth into the insulation. Sensor 111,121,131 associated with respective operating tools 110,120,130 provide respective sensor signals 112,122,132 indicative of the actual configuration of the operating tools. Control system 300 provides display data 310,320,330 to display 200, respectively to a graphical unit 210 of display 200, for displaying an animatable representation 5 of the tooled-cable 2. Advantageously, possible failure modes of the tooled-cable 2, respectively individual components of the tooled-cable 2, are distinguishable from each other in the animatable representation. The display 200 comprises a graphical user interface, for instance touchscreen 220, arranged to generate a failure mode control signal 350 indicative of a failure-mode of the tooled-cable 2. Based on the failure mode control signal 350, the control system 300 is arranged to adjust configuration settings of the cable processing machine 100, such as the configuration settings of the operating tools 110,120,130.

FIG. 3 shows a first still of the animatable representation 5 on the display according to the invention. The still shows a target tooled-cable 3, in this case a cable piece with stripped ends of 4.00 mm length on both sides. A section-wise representation of the tooled cable (for instance the left-hand cable end or the right-hand cable end) allows depicting in an animatable fashion a pictorial representation of specific parts of the tooled-cable 3. For instance, as depicted in this figure, the pictorial representation of a specific cable part (left-hand part/right hand-part) could show the target processed cable. Alternatively, it could (dynamically) show pictorial representations of possible failure modes of non-quality compliant tooled-cables. The pictorial representation of possible failure modes of non-quality compliant tooled cable parts may in one embodiment (dynamically) replace the pictorial representation of the target processed cable in the animatable representation 5. In another embodiment, the animatable representation 5 of the tooled cable may include a pop-up window in which pictorial representation(s) of possible failure modes of non-quality compliant tooled cable part(s) are depicted. Such a pop-up window may be depicted upon selection the appropriate section-wise representation.

FIG. 4 shows a second still of the animatable representation 5 on the display according to the invention. In this second still, upon selection of the pictorial representation of the left-hand cable part (see FIG. 3) a pop-up window is displayed including the pictorial representation(s) (such as an icon) of possible failure modes of non-quality compliant left-hand cable parts. As an example, the non-quality compliance of the left-hand part may be due to a partial cut of the cable's core conductor caused by misaligned or positioned cutting blades. As another example, the non-quality compliance of the left-hand part may be due to non-stripped insulator parts still present on the cable's end due to an incorrect opening distance of the blades during stripping. The pictorial representations of possible failure modes may comprise icons or low resolution photos, and may or may not be accompanied by explanatory text. Besides the pictorial representation of non-quality compliant tooled-cables, the animable representation 5 may also include pictorial representations of (non-quality compliant) machine parts, such as the tools 110,120,130 for operating the cable. The cognitive content of the pictorial representation(s) of possible failure modes thus relate to an internal state of the cable processing machine and help enabling an operator to properly operate the machine. Advantageously, presenting the pictorial representation(s) of possible failure modes of non-quality compliant (left-hand) cable parts enables a continued and/or guided human-machine interaction process to assist the operator in adjusting the setting of the cable processing machine by comparing a test-piece produced with the pictorial representation(s) depicted.

As shown on the still of the animatable representation 5 in FIG. 5, upon the guided selection of the pictorial representation of non-quality compliant cable or cable part which matches best with a test-piece produced, the animatable representation may display the relevant tool settings or other machine settings associated with the failure mode depicted in the pictorial representation. As an example, these relevant tool settings may be displayed as a pop-up once the selection of the failure mode of the (section-wise) representation of the cable has been made. Alternatively, the relevant tool settings may be displayed replacing the icon or pictorial representation of the non-compliant cable (part). In some embodiments, the configuration parameters may be presented as text (See FIG. 5). In alternative embodiments, the configuration parameters may be presented by (schematic) icons. Preferably, the configuration parameters are displayed in order of relevance for correcting the failure mode. Advantageously, the displayed order of relevance supports the operator intuitively in inputting adjusted values for the tool and/or machine settings.

The failure modes for the selected component or section of the cable represent elements of the configuration of the operating tools. A miss-setting of the (configuration of the) operating tools usually leads to typical non-compliant characteristics of the tooled cable. Examples of configuration elements are:
Opening gap of the cutting blades at deepest cutting point (“Einschneideöffnung”)
Opening gap of the cutting blades during pull-off of the isolation (“Öffnung beim Abziehen”)
Cutting pause time (“Einschneidepause”)
Pull-off acceleration (“Abziehbeschleunigung”)
Overdrawing distance at full/complete pull-off (“Überziehen bei Vollabzug”)

Each particular configuration element may be accompanied by numerical parameter values of the configuration setting with which the test-piece has been produced, and which have led to the non-quality compliance of the test-piece produced.

FIG. 6 shows a still of another embodiment the animatable representation 5 on the display. In this embodiment, upon the guided selection of the pictorial representation which matches best with a test-piece produced and to further guide and assist the operator in performing his technical task of tuning the cable processing machine, the animatable representation provides an indication assisting the operator in adjusting the parameter value of the configuration settings. Advantageously, the indication is a graphical indication, such an arrow. This assists the operator in adjusting the parameter in the appropriate direction, up or down. Advantageously, the indication may be comprise a colour component, for instance a graded colour scale. As an example, shades of colours from red via yellow to green and/or from light to dark may assist the operator by indicating the amount of the adjustment needed for (appropriately) tuning the cable processing machine. For instance, reddish tones may indicate relatively large adjustment amounts and greenish tones may indicate relatively small amounts, respectively may indicate the parameter has a (close to) optimal value.

FIG. 7 shows a fifth still of the animatable representation 5 on the display according to the invention. As can be discerned from the figure, besides displaying the target values of for instance the stripping length (Abisolierlänge) of the left-hand cable part, or centre-length (Länge) of the cable piece, the animatable representation furthermore depicts pictorially specific parts with failure modes of non-quality compliant tooled-cables. As an example, the difference between the target stripping length (4.00 mm) and the realised stripping length (3.50 mm) of the test-piece is displayed. As another example, the difference between the target centre-length (400.00 mm) and the realised centre-length (399.50 mm) of the test-piece is displayed. In this embodiment, upon the guided selection of the (section-wise) pictorial representation of the non-compliant left-hand cable part, and to further guide and assist the operator in performing his technical task of tuning the cable processing machine, the animatable representation may display, for example as a pop-up window, an overview of “recently used” (zuletzt verwendet) tool settings for tuning the cable processing machine for that particular cable part. In the present example, the following three recently used configuration elements are shown:
Stripping length measured (Abisolierlänge gemessen)
Cutting opening (Einschneideöffnung)
Opening during stripping (Öffnung beim Abziehen)

Examples of other configuration elements/tool settings are:
Stripping—pressure force (Abziehen—Druckkraft)
Stripping—speed (Abziehen—Geschwindigkeit)
Blow off section—Stopping time (Teilstück wegblasen: Nachlaufzeit)

Advantageously, the configuration elements shown (both identity and their parameter value) in the “recently used” overview may depend on the operation mode functionality for that particular cable part. In other words, they may be different for the left cable end, the central cable length, respectively the right cable length. More advantageously, the order of display of the configuration elements may be such that that most relevant configuration elements for tuning the cable processing machine are displayed at the top of the list.

As will be clear to the person skilled in the art, the embodiments and methods shown in the figures or described herein may also be combined and interchanged within the concept of the invention. As an example, also the “recently used” overview may include the (direction) indication assisting the operator in adjusting the parameter value of the configuration settings.

As a further example, sensor(s) 111,121,131 associated with respective operating tool(s) 110,120,130 may in the sense of this invention be an optical, electric, magnetic, electro-magnetic, piezo-electric sensor, or the like for providing respective sensor signal(s) 112,122,132 indicative of the actual configuration of the operating tools. Thus, these sensor(s) may determine the appropriate physical parameters, such as position, distance, orientation, or speed, of the associated tool(s) after a control signal(s) from central control system 300 has been effectuated to appropriately configure the tool(s). In the sense of this invention, the sensor may also be an (active) controller providing an operating signal for open-loop control of the appropriate physical parameter. As an example of such open-looped control, the controller may provide an operating signal to a stepping motor arranged to configure an associated tool. The sensor signal in the sense of the invention corresponds in this case to the operating signal for the stepper motor, since these are well known to have an inherent ability to control position, as they have built-in output steps. This allows them to be used as an open-loop position control, without any feedback encoder, as their drive signal specifies the number of steps of movement to rotate. The operating signal for driving the stepper motor in this example may hence be used as sensor signal.

As yet another example, in an embodiment, rather than a schematic representation of the failure mode as depicted in FIGS. 4 and 5, the representation of the failure mode my be a photo of a typical non-compliant tooled-cable part.

### List of Reference Signs

1 Blank-cable
2 Tooled-cable
3 Cable type
5 Animatable representation
100 Cable processing machine
110 Operating tool—cutting blades
111 Sensor—cutting blades
112 Sensor signal—cutting blades
120 Operating tool—stripping blades
121 Sensor—stripping blades
122 Sensor Signal—stripping blades
130 Operating tool—alignment grippers
131 Sensor—alignment grippers
132 Sensor signal—alignment grippers
200 Display
210 Graphic unit
220 Touch-screen
300 Control system
310 Display data
320 Display data
330 Display data
350 Failure-mode control signal
360 Artificial intelligence unit

1. A cable processing machine (100) for the processing of a blank-cable (1) into a tooled-cable (2), the cable processing machine comprising an operating tool (110, 120, 130), a sensor (111, 121, 131), a display (200), and a control system (300);
wherein the control system (300) is arranged to set a target configuration of the operating tool (110, 120, 130) based on a cable-type (3) of the blank-cable (1) to be processed and based on the desired target specification of the tooled-cable;
wherein the sensor (111, 121, 131) provides a sensor signal (112, 122, 132) indicative of the actual configuration of the operating tool (110, 120, 130);
wherein the control system (300) is further arranged to provide display data (310, 320, 330) on the basis of the sensor signal (112, 122, 132) and the cable-type (3), which display data are displayable on the display (200);
wherein individual items of the display data (310, 320, 330) are displayable in an animatable representation (5) of the tooled-cable (2) on the display (200) in which possible failure modes for individual components of the tooled-cable (2) are distinguishable from each other.

2. The cable processing machine (100) according to claim 1, wherein the display (200) comprises a touch-screen (220) arranged to generate a failure-mode control signal (350) indicative of a failure-mode of the tooled-cable (2), and the control system (300) is arranged to adjust the configuration of the operating tools (110, 120, 130) based on the failure-mode control signal (350).

3. The cable processing machine (100) according to claim 1, wherein the animatable representation (5) comprises a section-wise representation of the tooled-cable (2).

4. The cable processing machine (100) according to claim 1, wherein the individual items of the display data (310, 320, 330) comprise configuration parameters of the operating tools associated with the failure mode displayed.

5. The cable processing machine (100) according to claim 4, wherein the configuration parameters are displayed in order of relevance for correcting the failure mode.

6. The cable processing machine (100) according to claim, wherein the configuration parameters are changeable by an operator.

7. The cable processing machine (100) according to claim 1, wherein the individual items of the display data (310, 320, 330) comprise explanatory advice on the relationship between the occurrence of a failure mode and a setting of the configuration parameters of the operating tools (110, 120, 130) associated with that failure mode.

8. The cable processing machine (100) according to claim 2, wherein the control system (300) comprises an artificial intelligence unit (360) for determining the adjustment of the configuration of the operating tools (110, 120, 130) based on the failure-mode control signal (350).

9. A method of operating a cable processing machine (100) for the processing of a blank-cable (1) into a tooled-cable (2) using an operating tool (110, 120, 130), the method comprising:
a) setting a target configuration of the operating tool (110, 120, 130) based on a cable-type (3) of the blank-cable (1) to be processed and based on the desired target shape of the tooled cable;
b) providing a sensor signal (112, 122, 133) indicative of the actual configuration of the operating tool (110, 120, 130);
c) providing display data (310, 320, 330) on the basis of the sensor signal (112, 122, 133) and the cable-type (3);
d) displaying individual items of the display data (310, 320, 330) in an animatable representation (5) of the tooled-cable (2) in which possible failure modes of individual components of the tooled-cable (2) are distinguishable from each other.

10. A computer program product comprising instructions which, when the program is executed by a computer, cause the computer to carry out the method of claim 9.

11. The cable processing machine according to claim 2, wherein the individual items of the display data comprise configuration parameters of the operating tools associated with the failure mode displayed, and
wherein the configuration parameters are changeable when the failure-mode control signal comprises information relating to the changed configuration parameter.
